(19) United States
(12) Patent Application Publication
(10) Pub. No.: US 2007/0098148 A1
(43) Pub. Date: May 3, 2007

(54) Aroma releasing patch on mobile telephones

(76) Inventor: Kenneth Nathaniel Sherman, Las Vegas, NV (US)

Correspondence Address: Mark A. Litman & Associates, P.A.;York Business Center, Suite 205, 3209 West 76th St., Edina, MN, 55435, US

(21) Appl. No.: 11/250,814

(22) Filed: Oct. 14, 2005

(51) Int. Cl. H04M 1/00

(52) U.S. Cl. 379/452; 379/439; 379/451

(57) ABSTRACT

A removable attachment to a hand held or head held telephone unit has a regenerable or generable aroma releasing capability. The aroma may be initially released automatically and before use by the speaker and/or can be repeatedly released upon speaker action during use. The removable attachment may be as simple as an adhesively secured patch with aroma releasing capability on the surface away from the adhesive or a patch located between moving surface parts of the telephone so that whenever the moving part is moved (e.g., the case opened or closed, a power switch activated, a button positioned over the removable attachment is pressed, etc.), the aroma releasing attachment is stimulated and aroma is released.

### BACKGROUND OF THE INVENTION

1. Field of the Invention

The present invention relates to the use of mobile, cellular or portable telephones, to the use of aromatic agents on telephones, and the use of removable attachments, patches or appliques on telephones, telephone handsets, headsets, earsets and headphone cords to provide aromas or aromatherapeutic scents to the telephone user to combat tension and unpleasant environmental odors.

2. Background of the Art

Telephones, especially portable telephones and mobile phones are ubiquitous. These mobile phones are carried and used by persons everywhere and, to the consternation of many, at various speaking levels. Many users are under varying degrees of tension and are in conversations of varying degrees of importance, often within environments that are not under their control. Users may be involved in serious personal or business conversations where the environment may be highly emotional.

The aroma patch may be relatively small and still be effective. The aroma patch has to be small enough to be placed conveniently on to a mobile phone, a portable phone, a telephone handset, headset or a headset cord. Although, the invention provides for the patch to be close to the nose while the phone or headset is being used, it still must be designed to be maximally effective for a useful period of time.

Relevant disclosures have discussed improving the overall longevity of a fragrance by delaying the evaporation of the fragrance oils. A wide variety of techniques have been disclosed among them encapsulation of the perfume raw materials, for example within capsules or microcapsules; absorbing the materials to a surface, for example by using carbon or zeolites (disclosed in U.S. Pat. No. 6,033,679); occluding the release of the perfume raw materials, for example by the formation of a film; (disclosed in U.S. Pat. No. 3,939,099) complexing the perfume raw materials, for example by using cyclic oligosaccharides; and using hydroxyalkylated cyclodextrins.

U.S. Pat. No. ______ (Fraser) describes the use of a fragrance in microcapsules incorporated in the tear strip for a cigarette package to provide (by releasing specific aromas) an enhanced sensation of pleasure when the smoker opens the package. Published U.S. Patent Application No. 20030091466 (Benko et al.) describes a method and apparatus for releasing fragrance. An embodiment of the apparatus includes a first scented layer that releases a first portion of fragrance and a second scented layer, adjacent to the first layer that releases a second portion of fragrance. The second portion of fragrance is released after the first portion of fragrance is released. Exemplary applications include air fresheners and fragrance samplers.

U.S. Pat. No. 6,769,428 (Cronk et al.) describes nasal dilators and strips, methods of their manufacture, and methods for improving the breathing of individuals are provided. The strips and dilators include an elongated substrate, with or without a dilating component or portion, having top and bottom surfaces and a pressure-sensitive adhesive disposed on the bottom surface. The dilator is designed to provide a gentle expanding force to the nasal wall tissue when the dilator is adhesively attached to the nose. This invention further includes a cosmetic fragrance, an aromatic medication and/or transdermal medication disposed on the strips or dilators. In order to improve the shelf-life and in-use olfactory effectiveness of such products, fragrance delivery mechanisms are used. Separation of volatile oils and adhesives are also provided to minimize adhesive residue.

A South Korean cleaning apparatus contains a detergent with aroma-essence oil: “Detergent used for Phone Clean is completely safe for human body and contains aroma essence oil so that the cleaner smells aroma fragrance.” Note that the “cleaner,” not the user, smells the aroma. This would be because an essence oil in a detergent solution would not reliably leave an aroma, after washing, unless the detergent were designed to be an ineffective cleaner. Otherwise the oil would be emulsified and washed away. (See: http://www.textually.org/textually/archives/2005/05/008377.htm)

Encapsulated materials have been used for many years in a wide variety of commercial applications. Early uses of encapsulated materials included paper coated with capsules bearing coloring material therein which could be used as a recording medium. U.S. Pat. No. 3,016,308 discloses one of the early efforts using encapsulated material as the image source on recording paper. U.S. Pat. Nos. 4,058,434 and 4,201,404 show other methods of application of encapsulated coloring materials on paper substrates to be used as imaging media and the like. U.S. Pat. No. 3,503,783 shows microcapsules having coloring material therein which are rupturable by the application of heat, pressure and/or radiation because of a metal coating on the surface of the capsule. These rupturable microcapsules, in one embodiment, may be secured between a substrate and a photoconductive top coat to enable photosensitive imaging of the system.

A wide variety of processes exist by which microcapsules can be manufactured. These varied processes provide different techniques for producing capsules of varying sizes, alternative materials for the composition of the capsule shell and various different functional materials within the shell. Some of these various processes are shown in U.S. Pat. Nos. 3,516,846; 3,516,941; 3,778,383; 4,087,376; 4,089,802; 4,100,103 and 4,251,386 and British Patent specification Nos. 1,156,725; 2,041,319 and 2,048,206. A wide variety of different materials may also be used in making the capsule shells. A popular material for shell formation is the polymerization reaction product between urea and formaldehyde or melamine and formaldehyde, or the polycondensation products of monomeric or low molecular weight polymers of dimethylolurea or methylolated urea with aldehydes. A variety of capsule forming materials are disclosed, for example, in U.S. Pat. Nos. 3,516,846 and 4,087,376 and U.K. Patent Specification Nos. 2,006,709 and 2,062,570.

U.S. Pat. No. 5,636,787 (Gowhari) describes an eyeglasses-attached aromatic dispensing device.

U.S. Pat. No. 2,560,681 (Berkowitz) relates to articles which may take the form of a clasp, clip, pin, plug or the like for holding perfumed or other material, diffusing an odor or generally volatile in its nature.”

U.S. Pat. No. 4,580,581 (Reece) describes a self deodorizing ash tray (using an insert).

U.S. Pat. No. 4,874,129 (DeSapio) describes a multi-laminate fragrance releasing device. This device uses a pressure sensitive adhesive release liner and a silicone layer of a fragrance oil-impregnated matrix of a silicone material selected from the group consisting of silicone elastomers, silicone elastomers having adhesive characteristics, and elastomeric silicone pressure sensitive adhesives. The patent describes affixing their devices to substrates such as automobiles, boats, toilet bowls, doors, suitcases, shoes, trash cans, handbags, and in closets

As shown in these references, the principal utility of microencapsulated materials is in the formation of a surface coated with the microcapsules in a binder. The microcapsules are ruptured by various means to release the material contained therein. In addition to release of physically observable materials such as ink in order to form a visible image, other types of active ingredients such as odor releasing materials, bacteriostatic materials, chemically active materials and the like have been provided in this manner.

U.S. Pat. No. 4,186,743 describes the use of microcapsules on a pressure sensitive adhesive between two surfaces on a sanitary napkin. When a cover layer is removed, capsules are broken and the fragrance is released.

U.S. Pat. No. 4,487,801 describes the use of a non-pressure sensitive adhesive layer between two surfaces, the layer having fragrance containing microcapsules therein. Upon separation of the two surfaces, the adhesive and the microcapsules are ruptured, releasing the fragrance. U.S. Pat. No. 4,720,417 shows a similar article in which the two surfaces are coated paper surfaces.

U.S. Pat. No. 4,988,557 (Charbonneau) describes similar fragrance releasing pull-apart sheets in which some of the microcapsules face adhesive material that ruptures the microcapsules when the sheets are separated, and some of the microcapsules remain unruptured available to release fragrance at a later time when the user chooses manually to rupture them.

Every patent and patent application cited herein is incorporated by reference for its information relating to capsules, microcapsules, manufacturing techniques, coating techniques and other enabling information.

### SUMMARY OF THE INVENTION

The presently described technology comprises the provision of a removable attachment to a mobile or portable telephone, telephone handset, cellular telephone, headset, iPod™, music player, earset, or headphone cord, the removable attachment having a regenerable or generable aroma releasing capability. The aroma is initially released manually or automatically and before use by the user and/or can be repeatedly released upon user action during use. The removable attachment may be as simple as an adhesively secured patch with aroma releasing capability on the surface away from the adhesive or a patch located between moving surface parts of the telephone so that whenever the moving part is moved (e.g., the case opened or closed, a power switch activated, a button pressed, etc.), the aroma releasing attachment is stimulated and aroma is released.

### BRIEF DESCRIPTION OF THE FIGURES

FIG. 1 shows a perspective view of a removable patch having an aroma releasing surface thereon.

FIG. 2 shows a cutaway view of a removable patch on a portable telephone surface, and with a removable patch located on an edge of the portable phone, where manual contact or case closing/opening friction or impact can stimulate fragrance release.

FIG. 3 shows a removable patch or clip-on attachment on the speaker portion and bridging portion of a head-worn telephone unit.

### DETAILED DESCRIPTION OF THE INVENTION

As noted in the background of the invention, numerous devices and systems have been provided for the immediate, long-term and/or controlled release of aromatic materials and fragrances. The present technology relates to the provision of materials having an aroma, particularly a beneficial, medicinal, pleasant or mood-enhancing or mood affecting aroma, and, most particularly, an aromatherapeutic aroma to the user of a telephone and particularly a portable or cellular telephone. It is also a capability of the present technology to provide such aromas on a personal basis as opposed to flooding a room or environment or even an adjacent neighbor or coworker with aromas that are undesirable to others. This can be done by structures exemplified by, but not limited to, those shown in the Figures.

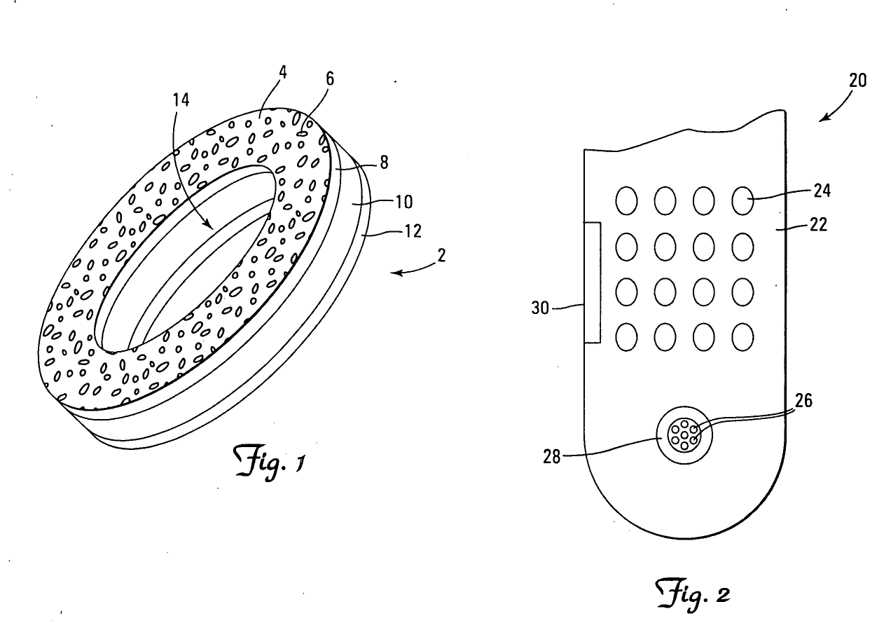

FIG. 1 shows a perspective view of a removable patch 2 having an aroma releasing surface 4 thereon. The aroma releasing surface 4 is shown with microcapsules 6 on the surface 4, but surfaces that exude aroma, have volatile aroma dissolved therein, or volatile aroma embedded therein may also be used. The aroma releasing surface is part of an aroma carrier layer 8 having an adhesive layer such as a pressure-sensitive or repositionable, or solvent soluble (especially water-soluble) adhesive layer 10. The adhesive layer may be further protected by a removable (preferably strippable) layer or sheet 12. A sheet, pad or strip (not shown) carrying multiple removable patches may be provided as a commercial item. An opening 14 is shown to allow positioning of the patch, if desired, at a location surrounding the microphone.

As well-known in the art, “pressure-sensitive” refers to any releasable adhesive or releasable tenacious means. Adhesive compositions suitable for nasal dilators and nasal strips include water-based pressure-sensitive adhesives, such as acrylate adhesives, thermoplastics “hot melt” adhesives, two-sided adhesive tape, elastomer-based adhesives, and acrylic adhesives. Good examples include polyacrylate adhesive, polyvinylethyl ether blend adhesive, and 3M1509 double-sided medical tape provided by 3M Inc., St. Paul, Minn. The 3M product is a double-sided transparent polyethylene film, coated on both sides with a hypoallergenic, pressure-sensitive acrylate adhesive, supplied on a paper liner. Of course, adhesive layers need not be a pressure-sensitive type at all, since once the resilient member and backing layer are adhered to the substrate, it is undesirable for these layers to separate during application or removal of the dilator from the nose.

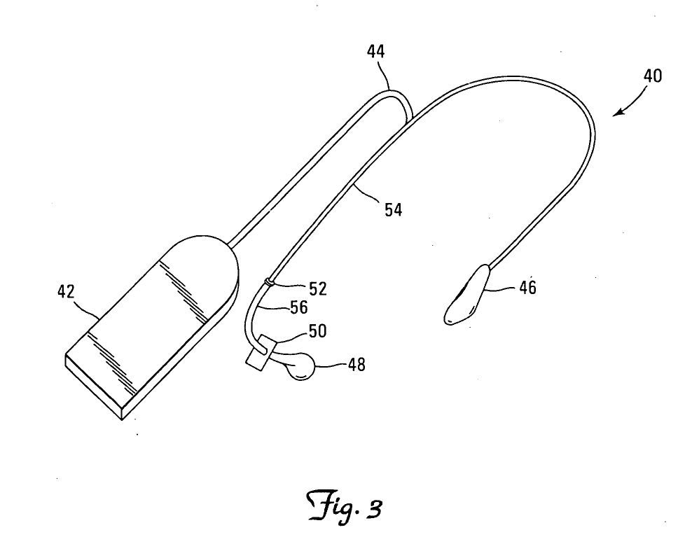

FIG. 2 shows a cutaway view of a removable patch 28 on a portable telephone 20 having a user active surface 22. Another removable patch 30 is located on an edge of the portable phone surface 22. Manual contact (especially a finger or fingernail) or friction or impact from a sliding/opening/closing cover can stimulate fragrance release. The removable patch 28 is shown surrounding the microphone hole(s) 26 on the portable phone. The patch 28 in no way interferes with the use of buttons 24 on the phone 20. The second patch 30 is positioned in a location where convenient hand or finger placement can, if the user chooses, activate aroma release, as by rupturing capsules in the patch 30 or heating the surfaces in the patch 30. The location of the second (by second is meant only the second in the Figure and not that it is required in addition to another patch) patch 30 is such that when the case cover or screen cover portion of a cell phone (not shown) is closed or opened with an eccentric rotation, friction or direct rupturing force is applied against the patch 30. This force will assist in rupturing any microcapsules or heating the surface of the patch 30 so that the release of aroma or fragrance is promoted.

FIG. 3 shows a removable patch 50 or clip-on attachment on the speaker portion 48 or bridging portion 56 of a head-worn telephone unit 40. In a standard cell phone, the earpiece cord 40 attaches to an earpiece 46 that fits in or attaches to the ear of a user, and a microphone unit 48 into which the user speaks. The ear piece and microphone may be connected by bridging sections 54 and 56, and the lower bridging section 56 may connect and disconnect to the upper bridging section 54. This connection may be a snap connection or screw-in connection 52 to facilitate positioning of the removable patch or sliding removable patch, 50 on the head-worn unit 40. The cell phone 42 is shown with a hardwire connection 40 to the head-worn unit 40. Bluetooth and other wireless speakers and microphones are worn on the ear. Some of these have boom microphones that extend down in the direction of the user's mouth (and hence the user's nose) to which the user may affix the removable patch, 50.

As noted, any fragrance or aroma may be used, with aromatherapeutic fragrances preferred in any format that allows persistent or triggered release of the aroma as described herein.

As used herein the term “fragrance oil” relates to the mixture of perfume raw materials that are used to impart the desired odor profile to a composition. As used herein the term “perfume raw material” relates to any chemical compound which is odiferous when in an un-entrapped state, for example in the case of pro-perfumes, the perfume component is considered, for the purposes of this invention, to be a perfume raw material, and the pro-chemistry anchor is considered to be the entrapment material. In addition “perfume raw materials” are defined by materials with a ClogP value preferably greater than about 0.1, more preferably greater than about 0.5, even more preferably greater than about 1.0. As used herein the term “ClogP” means the logarithm to base 10 of the octanol/water partition coefficient. This can be readily calculated from a program called “CLOGP” which is available from Daylight Chemical Information Systems Inc., 120 Vantis, Suite 550, Aliso Viejo, Calif. 92656, U.S.A. Octanol/water partition coefficients are described in more detail in U.S. Pat. No. 5,578,563

Within the present invention, by mixing together several different perfume raw materials, within the given “top note” to “middle and base note” weight ratio ranges, a fragrance oil can be achieved which, when used in a composition, particularly an aromatherapeutic composition, in conjunction with an entrapment material, is able to impart a particular long lasting character, which includes “top note” characters, to said composition. The mixture of perfume raw materials used will be carefully chosen and blended to achieve a fragrance oil with the desired overall fragrance character profile.

The fragrance oil itself can comprise any perfume raw material suitable for use in the composition. Overall the fragrance oil will most often be liquid at ambient temperatures and consist of a single individual perfume raw material. A wide variety of chemicals are known for fragrance uses, including materials such as aldehydes, ketones and esters. However, naturally occurring plant and animal oils and exudates comprising complex mixtures of various chemical components are also commonly known for use as fragrances. The individual perfume raw materials which comprise a known natural oil can be found by reference to journals commonly used by those skilled in the art such as “Perfume and Flavourist” and “Journal of Essential Oil Research.” In addition some perfume raw materials are supplied by the fragrance houses as mixtures in the form of “Proprietary Speciality Accords.” In order that fragrance oils can be developed with the appropriate character for the present invention the perfume raw materials have been classified based upon two key physical characteristics:
(i) boiling point (BP) measured at 1 atmosphere pressure. The boiling point of many fragrance materials are given in Perfume and Flavor Chemicals (Aroma Chemicals), Steffen Arctander (1969). Perfume raw materials for use in the present invention are divided into volatile raw materials (which have a boiling point of less than, or equal to, about 250° C.) and residual raw materials (which have a boiling point of greater than about 250° C., preferably greater than about 275° C.). Volatile raw materials, for the purposes of this invention, are considered to be those that impart “top note” i.e., light, fresh, fruity, citrus, green or delicate floral characters to the fragrance oil and the like. Similarly the residual perfume raw materials are considered to be those that impart “middle or base note” ie musk, sweet, balsamic, spicy, woody or heavy floral characters to the fragrance oil and the like. All perfume raw materials will preferably have boiling points (BP) of about 500° C. or lower and
(ii) An odor detection threshold which is defined as the lowest vapor concentration of that material which can be olfactorily detected. The odor detection threshold and some odor detection threshold values are discussed in e.g., “Standardized Human Olfactory Thresholds”, M. Devos et al, IRL Press at Oxford University Press, 1990, and “Compilation of Odor and Taste Threshold Values Data”, F. A. Fazzalar, editor ASTM Data Series DS 48A, American Society for Testing and Materials, 1978, both of said publications being incorporated by reference. Perfume raw materials for use in the present invention can be classified as those with a low odor detection threshold of less than 50 parts per billion, preferably less than 10 parts per billion and those with a high odor detection threshold which are detectable at greater than 50 parts per billion (values as determined from the references above).
   Since, in general, perfume raw materials refer to a single individual compound, their physical properties (such ClogP, boiling point, odor detection threshold) can be found by referencing the texts cited above. In the case that the perfume raw material is a natural oil, which comprises a mixture of several compounds, the physical properties of the complete oil should be taken as the weighted average of the individual components. In the case that the perfume raw material is a “Proprietary Speciality Accord,” the physical properties should be obtained from the Supplier.

In order to develop fragrance oils that are suitable for use in the present invention it is often useful that the weight ratio of volatile “top note” to residual “middle and base notes” perfume raw materials within the fragrance oil is in the range from about 1:20 to about 20:1, preferably from about 1:10 to about 10:1, more preferably from about 8:1 to about 1:2, most preferably from about 1.2:1 to about 1:1.2. It is preferred that the fragrance oil comprises about 5% or greater, more preferably about 5% to about 99%, even more preferably from about 5% to about 70%, further more preferably from about 10% to about 60%, and most preferably from about 25% to about 60%, by weight of fragrance oil, of volatile “top note” perfume raw materials i.e., with a boiling point of less than, or equal to, about 250° C. It is preferred that the fragrance oil also comprises from about 0.01% to about 95%, preferably from about 5% to about 85%, more preferably from about 10% to about 60%, by weight of fragrance oil, of the residual “middle and base note” perfume raw materials i.e., those with a boiling point of greater than about 250° C. In a very specific embodiment of this application, the weight ratio of volatile “top note” to residual “middle and base notes” perfume raw materials within the fragrance oil is in the range from about 1:20 to about 1:19 and less than about 5%, by weight of the fragrance oil, of top note perfume raw materials. This embodiment allows for the fragrance character of a composition to be prolonged, but is useful for preparing fragrance characters wherein the specific “top note” characters are less desirable, for example fragrance for use in male toiletries and the like.

Additionally, in order to develop fragrance oils with an appropriate character profile over time, it is preferred that within the fragrance oil, a balance of perfume raw materials are used which have a low odor detection threshold. It is preferred for use herein that the “top note” perfume raw materials within the fragrance oil comprise 5% or greater, by weight of the “top note” perfume raw materials, of “top note” perfume raw materials which have an odor detection level of less than, or equal to, 50 parts per billion, preferably less than 10 parts per billion. In addition it is highly preferred that the “middle or base note” perfume raw materials within the fragrance oil comprise 10% or greater, more preferably 20% or greater and most preferably 50% or greater, by weight of the “middle or base note” raw materials, of “middle notes” or “base notes”, or a mixture thereof, with an odor detection threshold of less than, or equal to, 50 parts per billion, preferably less than 10 parts per billion. Since materials with low odor detection levels can be detected when only very small levels are present, they are particularly useful for developing the long lasting character of the fragrance oil released over time from the entrapment material. Overall it is preferred that the whole fragrance oil comprise from about 5% to about 95%, preferably from about 20% to about 75%, more preferably from about 25% to about 50% and even more preferably from about 25% to about 40%, by weight of the fragrance oil, high odor impact perfume raw materials.

It is a further feature that the fragrance oil preferably comprises a balance of perfume raw materials with a low odor detection threshold, such that the compositions can comprise lower levels of fragrance oil than would traditionally be present. This can be advantageous for minimizing skin sensitization and also for reducing overall costs. As such, compositions of the present invention can preferably comprise from about 1% to about 15%, more preferably from about 1% to about 8%, by weight, of fragrance oil.

In general a broad range of suitable perfume raw materials can be found in U.S. Pat. Nos. 4,145,184, 4,209,417, 4,515,705, and 4,152,272. Non-limiting examples of perfume raw materials which are useful for blending to formulate fragrance oils for the present invention are given below. Any perfume raw materials, natural oils or Proprietary Speciality Accords known to a person skilled in the art can be used within the present invention.

Volatile perfume raw materials (“top notes”) useful in the present invention are selected from, but are not limited to, aldehydes with a relative molecular mass of less than or equal to about 200; esters with a relative molecular mass of less than or equal to about 225; terpenes with a relative molecular mass of less than or equal to about 200; alcohols with a relative molecular mass of less than or equal to about 200; ketones with a relative molecular mass of less than or equal to about 200; nitriles; pyrazines; and mixtures thereof.

Examples of volatile “top note” perfume raw materials having a boiling point of less than, or equal to, 250° C., with a low odor detection are selected from, but are not limited to, anethol; methyl heptine carbonate; ethyl aceto acetate; para cymene; nerol; decyl aldehyde; para cresol; methyl phenyl carbinyl acetate; ionone alpha; ionone beta; undecylenic aldehyde; undecyl aldehyde; 2,6-nonadienal; nonyl aldehyde; and octyl aldehyde. Further examples of volatile perfume raw materials having a boiling point of less than, or equal to, 250° C., which are generally known to have a low odor detection threshold include, but are not limited to, phenyl acetaldehyde; anisic aldehyde; benzyl acetone; ethyl-2-methyl butyrate; damascenone; damascone alpha; damascone beta; flor acetate; frutene; fructone; herbavert; iso cyclo citral; methyl isobutenyl tetrahydro pyran; isopropyl quinoline; 2,6-nonadien-1-ol; 2-methoxy-3-(2-methylpropyl)-pyrazine; methyl octine carbonate; tridecene-2-nitrile; allyl amyl glycolate; cyclogalbanate; cyclal C; melonal; gamma nonalactone; and cis 1,3-oxathiane-2-methyl-4-propyl- (Mark, ?)

Other volatile “top note” perfume raw materials having a boiling point of less than, or equal to, 250° C., which are useful in the present invention, which have a high odor detection threshold, are selected from, but are not limited to, benzaldehyde; benzyl acetate; camphor; carvone; borneol; bornyl acetate; decyl alcohol; eucalyptol; linalool; hexyl acetate; iso-amyl acetate; thymol; carvacrol; limonene; menthol; iso-amyl alcohol; phenyl ethyl alcohol; alpha pinene; alpha terpineol; citronellol; alpha thujone; benzyl alcohol; beta gamma hexenol; dimethyl benzyl carbinol; phenyl ethyl dimethyl carbinol; adoxal; allyl cyclohexane propionate; beta pinene; citral; citronellyl acetate; citronellal nitrile; dihydro myrcenol; geraniol; geranyl acetate; geranyl nitrile; hydroquinone dimethyl ether; hydroxycitronellal; linalyl acetate; phenyl acetaldehyde dimethyl acetal; phenyl propyl alcohol; prenyl acetate; triplal; tetrahydrolinalool; verdox; and cis-3-hexenyl acetate;

Examples of residual “middle and base note” perfume raw materials having a boiling point of greater than 250° C., which have a low odor detection threshold are selected from, but are not limited to, ethyl methyl phenyl glycidate, ethyl vanillin; heliotropin; indol; methyl anthranilate; vanillin; amyl salicylate; and coumarin Further examples of residual perfume raw materials having a boiling point of greater than 250° C. which are generally known to have a low odor detection threshold include, but are not limited to, ambrox; bacdanol; benzyl salicylate; butyl anthranilate; cetalox; ebanol; cis-3-hexenyl salicylate; lilial; gamma undecalactone; gamma dodecalactone; gamma decalactone; calone; cymal; dihydro iso jasmonate; iso eugenol; lyral; methyl beta naphthyl ketone; beta naphthol methyl ether; para hydroxylphenyl butanone; 8-cyclohexadecen-1-one; oxocyclohexadecen-2-one/habanoli-de; florhydral; and intreleven aldehyde.

Other residual “middle and base note” perfume raw materials having a boiling point of greater than 250° C. which are useful in the present invention, but which have a high odor detection threshold, are selected from, but are not limited to, eugenol; amyl cinnamic aldehyde; hexyl cinnamic aldehyde; hexyl salicylate; methyl dihydro jasmonate; sandalore; veloutone; undecavertol; exaltolide/cyclopentadecanolide; zingerone; methyl cedrylone; sandela; dimethyl benzyl carbinyl butyrate; dimethyl benzyl carbinyl isobutyrate; triethyl citrate; cashmeran; phenoxy ethyl isobutyrate; iso eugenol acetate; helional; iso E super; ionone gamma methyl; pentalide; galaxolide; and phenoxy ethyl propionate.

Entrapment Material

Compositions of the present invention may also comprise an entrapment material preferably at a level of from about 0.1% to about 95%, preferably from about 0.5% to about 50%, more preferably from about 1% to about 25% and even more preferably from about 2% to about 8%, by weight, of an entrapment material. As defined herein an “entrapment material” is any material that after application of the composition to a substrate, suppresses the volatility of the perfume raw materials within the fragrance oil thus delaying their evaporation. It is not necessary that the entrapment material forms an association with the perfume raw material within the composition itself, only that this association exists on the substrate after application of the composition. Non limiting examples of mechanisms by which the delay in evaporation may occur are by the entrapment material reversibly or irreversibly, physically or chemically associating with the perfume raw material through complexing, encapsulating, occluding, absorbing, binding, or otherwise adsorbing the perfume raw materials of the fragrance oil.

As defined herein “reversible entrapment” means that the entrapment material-perfume raw material association can be broken down so that the entrapment material and perfume raw materials are released from each other. As defined herein “irreversible entrapment” means that the entrapment material-perfume raw material association cannot be broken down. As defined herein “chemically associated” means that the entrapment material and perfume raw material are linked through a covalent, ionic, hydrogen or other type of chemical bond. As defined herein “physically associated” means that the entrapment material and perfume raw material are linked through a bond with a weaker force such as a Van der Waals force. Highly preferred is that, upon the substrate, the entrapment material and the perfume raw material form a reversible physical or chemical association.

As defined herein “to delay the evaporation of an aroma providing material, aromatherapeutic material, or a perfume raw material” means to slow down or inhibit the evaporation rate of said material from the substrate such that the fragrance “top note” character of the perfume raw material is detectable for at least 2 hours after application to the substrate.

Entrapment materials for use herein are selected from polymers; capsules; microcapsules and nanocapsules; liposomes; pro-perfumes selected from more than 1 type of pro-chemistry; film formers; absorbents; cyclic oligosaccharides and mixtures thereof. Preferred are pro-perfumes selected from more than 1 type of pro-chemistry, absorbents and cyclic oligosaccharides and mixtures thereof. Highly preferred are cyclic oligosaccharides.

Within the entrapment association, it is preferred that the weight ratio of top note perfume raw material to entrapment material within the associated form is in the range from about 1:20 to about 20:1, more preferably in the range from about 1:10 to about 10:1, even more preferably in the range from about 1:10 to about 1:4.

Complexation Using, for Example, Cyclic Oligosaccharides

For compositions of the present invention, the entrapment material may act reversibly, and either chemically, and/or physically, complexes the perfume raw materials. Non limiting, and preferred, examples of entrapment materials that can act in this way are cyclic oligosaccharides or mixtures of different cyclic oligosaccharides.

As used herein, the term “cyclic oligosaccharide” means a cyclic structure comprising six or more saccharide units. Preferred for use herein are cyclic oligosaccharides having six, seven, or eight saccharide units and mixtures thereof, more preferably, six or seven saccharide units and even more preferably, seven saccharide units. It is common in the art to abbreviate six, seven and eight membered cyclic oligosaccharides to alpha, beta and gamma respectively.

The cyclic oligosaccharide of the compositions used for the present invention may comprise any suitable saccharide or mixtures of saccharides. Examples of suitable saccharides include, but are not limited to, glucose, fructose, mannose, galactose, maltose and mixtures thereof. However, preferred for use herein are cyclic oligosaccharides of glucose. The preferred cyclic oligosaccharides for use herein are alpha-cyclodextrins or beta-cyclodextrins, or mixtures thereof, and the most preferred cyclic oligosaccharides for use herein are beta-cyclodextrins.

The cyclic oligosaccharide, or mixture of cyclic oligosaccharides, for use herein may be substituted by any suitable substituent or mixture of substituents. Herein the use of the term “mixture of substituents” means that two or more different suitable substituents can be substituted onto one cyclic oligosaccharide. The derivatives of cyclodextrins consist mainly of molecules wherein some of the OH groups have been substituted. Suitable substituents include, but are not limited to, alkyl groups; hydroxyalkyl groups; dihydroxyalkyl groups; (hydroxyalkyl)alkylenyl bridging groups such as cyclodextrin glycerol ethers; aryl groups; maltosyl groups; allyl groups; benzyl groups; alkanoyl groups; cationic cyclodextrins such as those containing 2-hydroxy-3-(dimethylamino)propyl ether; quaternary ammonium groups; anionic cyclodextrins such as carboxyalkyl groups, sulfobutylether groups, sulfate groups, and succinylates; amphoteric cyclodextrins; and mixtures thereof.

The substituents may be saturated or unsaturated, straight or branched chain. Preferred substituents include saturated and straight chain alkyl groups, hydroxyalkyl groups and mixtures thereof. Preferred alkyl and hydroxyalkyl substituents are selected from C1-C8 alkyl or hydroxyalkyl groups or mixtures thereof. More preferred alkyl and hydroxyalkyl substituents are selected from C1-C6 alkyl or hydroxyalkyl groups or mixtures thereof. Even more preferred alkyl and hydroxyalkyl substituents are selected from C1-C4 alkyl or hydroxyalkyl groups and mixtures thereof. Especially preferred alkyl and hydroxyalkyl substituents are propyl, ethyl and methyl, more especially hydroxypropyl and methyl and even more preferably methyl.

The cyclic oligosaccharides of the compositions used for the present invention are preferably soluble in both water and ethanol. As used herein “soluble” means at least about 0.1 g of solute dissolves in 100 ml of solvent, at 25° C. and 1 atmosphere of pressure. Preferably the cyclic oligosaccharides for use herein have a solubility of at least about 1 g/100 ml, at 25° C. and 1 atmosphere of pressure. Preferred is that cyclic oligosaccharides are present only at levels up to their solubility limits in a given composition at room temperature. A person skilled in the art will recognize that the levels of cyclic oligosaccharides used in the present invention will also be dependent on the components of the composition and their levels, for example the solvents used or the exact fragrance oils, or combination of fragrance oils, present in the composition. Therefore, although the limits stated for the entrapment material are preferred, they are not exhaustive.

Encapsulation Using Capsules, Micro-Capsules and Nanocapsules

Encapsulation of fragrances within capsules, micro-capsules or nanaocapsules which are broken down by environmental triggers can be used to reduce the volatility of fragrance oils by surrounding the oil by small droplets as a resistant wall. The encapsulation may be either water sensitive or insensitive. In the first case the fragrance is released when the encapsulated particle is affected by moisture loss from the skin; while in the second case the capsule wall must be ruptured mechanically before the fragrance is released. Encapsulation techniques are well known in the art including U.S. Pat. Nos. 3,539,465; 3,455,838.

Moisture sensitive capsules, micro-capsules and nanocapsules may be formed from, but are not limited to, a polysaccharide polymer. Examples of suitable polymers are dextrins, especially low-viscosity dextrins including maltodextrins. A particularly preferred example of a low viscosity dextrin is one which, as a 50% dispersion in water, has a viscosity at 25° C., using a Brookfield Viscometer fitted with an “A” type T-Bar rotating at 20 rpm in helical mode, of 330+−0.20 mPa·s. This dextrin is known as Encapsul 855 and is available from National Starch and Chemicals Ltd. A further example of a polysaccharide that can be used to form moisture sensitive capsules is gum acacia.

Time release microcapsules are also suitable for use in compositions of the present invention for entrapping hydrophobic perfume raw materials. Such compositions comprise the perfume raw materials encapsulated in a wax or polymer matrix which in turn is coated with a compatible surfactant. The wax or polymers used to form the matrix have a melting point in the range from about 35° C. to about 120° C. at 1 atmosphere pressure.

Occlusion Using Film Formers

Film formers can also be used to reduce the volatility profile of perfume raw materials. When the fragrance is applied to a substrate, such as the skin, it is believed that film formers entrap the perfume oils during the evaporation of the volatile solvent thus hindering the release of the volatile material. Any film former which is compatible with the perfume raw materials may be used. Preferably, the film former will be soluble in water-ethanol mixture. Film former materials useful in this invention include, but are not limited to, ionic and non-ionic derivatives of water soluble polymers. Examples of suitable film forming materials are water soluble polymers containing a cationic moiety such as polyvinyl pyrrolidine and its derivatives having a molecular weight of 50,000 to 1,000,000. Other examples of ionic polymeric film forming materials are cationic cellulose derivatives sold under the trade names of Polymer JR (Union Carbide), Klucel™ GM (Hercules) and ethoxylated polyethyleneimine sold under the trade name PEI 600 (Dow). Examples of suitable cellulosic derivatives include hydroxymethyl cellulose, hydroxypropyl methylcellulose and hydroxyethyl cellulose. Another film former is benzophenone. Non limiting examples of film forming materials are given in U.S. Pat. No. 3,939,099. Other Polymers that are additional non-limiting examples of other polymer systems that can be used include water soluble anionic polymers e.g., polyacrylic acids. Their water-soluble salts are useful in the present invention to delay the evaporation rate of certain amine-type odors. Preferred polyacrylic acids and their alkali metal salts have an average molecular weight of less than about 20,000, preferably less than 10,000, more preferably from about 500 to about 5,000. Polymers containing sulfonic acid groups, phosphoric acid groups, phosphonic acid groups and their water soluble salts, and their mixtures thereof, and mixtures with carboxylic acid and carboxylate groups, are also suitable.

Water soluble polymers containing both cationic and anionic functionalities are also suitable. Examples of these polymers are given in U.S. Pat. No. 4,909,986. Another example of water-soluble polymers containing both cationic and anionic functionalities is a copolymer of dimethyldiallyl ammonium chloride and acrylic acid, commercially available under the trade name Merquat 280® from Calgon, Inc.

As used herein, “volatile” refers to substances with a significant amount of vapor pressure under ambient conditions, as is understood by those in the art. The volatile solvents for use herein will preferably have a vapor pressure of about 2 kPa or more. More preferably about 6 kPa or more at 25° C. The volatile solvents for use herein will preferably have a boiling point, under 1 atm, of less than about 150° C., more preferably less than about 100° C., even more preferably less than about 90° C., even more preferably less than about 80° C.

Preferably, the volatile solvents for use herein will be safe for use on a wide range of substrates, particularly the wide range of plastics that are used to manufacture consumer electronics as well as human or animal skin or hair. Suitable volatile solvents include, but are not limited to, those found in the CTFA International Cosmetic Ingredient Dictionary and Handbook, 7th edition, volume 2 P1670-1672, edited by Wenninger and McEwen (The Cosmetic, Toiletry, and Fragrance Association, Inc., Washington, D.C., 1997). Conventionally used volatile solvents include C.sub.3-C.sub.14 saturated and unsaturated, straight or branched chain hydrocarbons such as cyclohexane, hexane, heptane, isooctane, isopentane, pentane, toluene, and xylene; halogenated alkanes such as perfluorodecalin; ethers such as dimethyl ether, and diethyl ether; straight or branched chain alcohols and diols such as methanol, ethanol, propanol, isopropanol, n-butyl alcohol, t-butyl alcohol, benzyl alcohol, butoxypropanol, butylene glycol, and isopentyldiol; aldehydes and ketones such as acetone; volatile silicones such as cyclomethicones, for example octamethyl cyclo tetrasiloxane and decamethyl cyclopentane siloxane; volatile siloxanes such as phenyl pentamethyl disiloxane, phenylethylpentamethyl disiloxane, hexamethyl disiloxane, methoxy propylheptamethyl cyclotetrasiloxane, chloropropyl pentamethyl disiloxane, hydroxypropyl pentamethyl disiloxane, octamethyl cyclotetrasiloxane, decamethyl cyclopentasiloxane; and propellants, and mixtures thereof. Preferred volatile solvents are ethers such as dimethyl ether, diethyl ether; straight or branched chain alcohols and diols such as methanol, ethanol, propanol, isopropanol, n-butyl alcohol, t-butyl alcohol, benzyl alcohol, butoxypropanol, butylene glycol, isopentyldiol; volatile silicones such as cyclomethicones, for example octamethyl cyclo tetrasiloxane and decamethyl cyclopentane siloxane and propellants, and mixtures thereof. More preferred for use herein are C1-C4 straight chain or branched chain alcohols for example methanol, ethanol, propanol, isopropanol and butanol and mixtures thereof, and most preferred for use herein is ethanol.

Nonvolatile Solvents

While the compositions of the present invention must comprise a volatile solvent they may also comprise “nonvolatile” solvents. Suitable non-volatile solvents include, but are not limited to, benzyl benzoate, diethyl phthalate, isopropyl myristate, and mixtures thereof. These solvents would tend to persist for longer periods of times on a telephone surface before evaporating, and therefore would tend to hold aromas on a useful surface for a longer period of time.

This invention includes extended release means, including such individual fragrance delivery mechanisms as fixatives, gels, starches, carriers, porous hydrophilic inorganics, micro-capsules, cellulosic carriers, cyclodextrine coatings and body-activated coatings, such as those which release fragrant oils upon achieving a certain temperature, reaching a certain pH, or, when they come in contact with liquid perspiration. The fragrance delivery mechanisms of this invention help to contain the essence of the volatile aromatic compounds over a greater period of time to extend the shelf life, and increase the in-use olfactory effectiveness. Additional means for overcoming olfactory saturation are provided which include at least two different fragrance delivery systems and/or at least two different fragrances (or a fragrance and an aromatherapeutic material or medication). The different delivery systems can deliver an aromatic drug, or fragrance under different use conditions, or at different times during use to keep the product fresh to the wearer. For example, re-encapsulation can be used to release and preserve fragrance oils or medications during the occurrence and evaporation of perspiration during athletic events, or the rise and fall of body temperature, caused by viral infections or flu symptoms.

The substrate may include any thin (e.g., less than 4 mm thick), flexible, breathable or non-breathing material for maximizing comfort. Preferably this material permits the passage of air and moisture vapor, such as perspiration, but inhibits the passage of dirt and liquid perspiration or rain water, etc. The elongated substrate can include, for example, a woven or non-woven fabric material, such as non-woven, polyester fabric. One good example is a fabric produced by DuPont E.I. de Nemours & Co., Inc. under the trademark Sontara®. Alternatively, the elongated substrate can include a thermoplastic woven or non-woven fabric, such as spun-bonded, or melt-blown, polyethylene or polypropylene fibers, which in sufficient-thickness can be “self-resilient,” or capable of gently opening nasal passage ways when adhesively applied to exterior nasal tissue, as discussed in more detail below. The substrate can also be treated with the aromatic material or medication of this invention, along with a hydrophilic or hydrophobic additive for absorbing or repelling sweat or moisture on a selective basis.

Suitable fragrance compounds and compositions for this invention are disclosed in U.S. Pat. No. 4,145,184, Brain and Cummins, issued Mar. 20, 1979; U.S. Pat. No. 4,209,417 (Whyte); U.S. Pat. No. 4,515,705 (Moeddel); and U.S. Pat. No. 4,152,272 (Young), all of said patents being incorporated herein by reference.

Fragrances can be classified according to their volatility. The highly volatile, low boiling, ingredients typically have boiling points of about 250° C. or lower. The moderately volatile ingredients are those having boiling points of about 250° C. to about 300° C. The less volatile, high boiling, ingredients are those having boiling points of about 300° C. or higher. Many of the fragrance ingredients as discussed hereinafter, along with their odor and/or flavor characters, and their physical and chemical properties, such as boiling point and molecular weight, are given in “Perfume and Flavor Chemicals (Aroma Chemicals)” Steffen Arctander, 1969, incorporated herein by reference.

Examples of the highly volatile, low boiling, fragrance ingredients, also called “top notes,” are: anethole, benzaldehyde, benzyl acetate, benzyl alcohol, benzyl formate, iso-bornyl acetate, camphene, cis-citral(neral), citronellal, citronellol, citronellyl acetate, para-cymen, decanal, dihydrolinalool, dihydromyrcenol, dimethyl phenyl carbinol, eucalyptol, geraniol, geraniol, geranyl acetate, geranyl nitrile, cis-3-hexenyl acetate, hydroxycitronellal, d-limonene, linalool, linaool oxide, linalyl acetate, linalyl propionate, methyl anthranilate, alpha-methyl ionone, methyl nonyl acetaldehyde, methyl phenyl carbinyl acetate, laevomenthyl acetate, menthone, iso-menthone, myrcene, myrcenyl acetate, myrocenol, nerol, neryl acetate, nonyl acetate, phenyl ethyl alcohol, alpha-pinene, beta-pinene, gamma-terpinene, alpha-terpineol, beta-terpineol, terpinyl acetate, and vertenex(para-tertiary-butyl cyclohexyl acetate). Some natural oils also contain large percentages of highly volatile ingredients. For example, lavandin contains as major components: linalool; linalyl acetate; geraniol; and citronellol. Lemon oil and orange terpenes both contain about 95% of d-limonene.

Examples of moderately volatile fragrance ingredients, also called “middle notes,” are: amyl cinnamic aldehyde, iso-amyl salicylate, beta-caryophyllene, cedrene, cinnamic alcohol, coumarin, dimethyl benzyl carbinyl acetate, ethyl vanillin, eugenol, iso-eugenol, flor acetate, heliotropine, 3-cis-hexenyl salicylate, hexyl salicylate, lilial(para-tertiarybutyl-alpha-methyl hydrocinnamic aldehyde), gamma-methyl ionone, nerolidol, patchouli alcohol, phenyl hexanol, beta-selinene, trichloromethyl phenyl carbinyl acetate, triethyl citrate, vanilla and veratraldehyde. Cedarwood terpenes are composed mainly of alpha-cedrene, beta-cedrene, and other C15H24 sesquiterpenes.

Examples of the less volatile, high boiling, perfume ingredients, referred to as “bottom notes,” are: benzophenone, benzyl salicylate, ethylene brassylate, galaxolide(1,3,4,6,7,8-hexahydro-4,6,6,7,8,8-hexamethyl-cyclopenta-gama-2-benzopyran), hexyl cinamic aldehyde, lyral(4-(4-hydroxy4-methyl pentyl)-3-cyclohexene-10-carboxaldehyde), methyl cedrylone, methyl dihydro jasmonate, methyl-beta-naphthyl ketone, musk indanone, musk ketone, musk tibetene, and phenylethyl phenyl acetate.

Various other non-active, aromatic components (e.g., aldehydes and esters) may also be used to impart fruit scents. These aromatics include, for example, benzaldehyde (cherry, almond); citral (lemon, lime); neral; decanal (orange, lemon); aldehyde C-8, aldehyde C-9 and aldehyde C-12 (citrus fruits); tolyl aldehyde (cherry, almond); 2,6-dimethyl-octanal (green fruit); and 2-dodecenal (citrus, mandarin). Mixtures of these aromatics can also be used.

Preferred examples of aromatic medications of this invention include camphor, ephedrine, eucalyptus oil, peppermint oil, menthol, methyl salicylate, bornyl acetate, lavender oil, or a combination of these. Menthol, because of therapeutic benefits which extend beyond its peppermint smell, is especially attractive as an antitussive, cooling agent and decongestant.

These and other aromatic active components are more fully described in 53 Federal Register 30561, Aug. 12, 1988, incorporated by reference herein.

There are several well known types of encapsulation that may be selected to provide a controlled release of a fragrance or medication in the present invention. For example, two suitable types of encapsulation include: (a) microcapsules that rupture, by contact pressure, or by partly or completely dissolving in water or perspiration, at the point of use so that the fragrance or medicinal component is transferred to the user's skin, (b) microcapsules that continually effuse the fragrance or medicinal component without rupturing, (c) multiphase capsules, such as those disclosed in U.S. Pat. No. 3,909,444 to Anderson et al., which include a water-soluble polymeric active within a liquid permeable, water-insoluble capsule wall, for example; and (d) microcapsules which are capable of re-encapsulation, as in, for example, when perspiration evaporates, as disclosed in U.S. Pat. No. 5,711,941 to Behan et al., said patents hereby incorporated by reference. Behan et al. discloses a number of self-emulsifying film-forming substances, like waxy starches and modified starches sold under the trade names N-Lok and Purity Gum BE available from National Starch and Chemical Co.

The fragrance carriers employed in the compositions of the present invention preferably comprise hydrophilic particles having a diameter of from about 0.001 micron to about 100 microns, preferably from about 0.01 to about 50 microns, more preferably from about 0.1 to about 20 microns. As used herein, a “hydrophilic carrier particle” means a particle which entraps a fragrance (e.g., perfume oil or medication) in the dry (e.g., neat) product and releases entrapped fragrance when the product is used, for example, when contacted by finger pressure or perspiration.

One type of inorganic carrier suitable for use in the present invention includes amorphous silica, precipitated silica, fumed silica, activated carbon, and aluminosilicates such as zeolite and alumina with a pore volume of at least 0.1 ml/g consisting of pores with a diameter between 4 and 100 A, which by their nature, are hydrophilic. Preferably, amorphous silica gel is used because of its high oil absorbency. Silica gel particles include SyloidR silicas such as Numbers: 72; 74, 221, 234; 235; 244; etc. Syloid® silicas are available from W. R. Grace & Co., Davison Chemical Division, P.O. Box 2117, Baltimore, Md. 21203. Such particles have surface areas of from about 250 to about 340 m.sup.2/g; pore volumes of from about 1.1 to about 1.7 cc/g; and average particle sizes of from about 2.5 to about 6 microns. Fumed silica particles have primary particle diameters of from about 0.007 to about 0.025 micron and include Cab-O-Sil® Numbers: L-90; LM-130; LM-5; M-5; PTG; MS-55; HS-5; and EH-5. Cab-O-Sil® silicas are available from Cabot Corp., P.O. Box 188, Tuscola, Ill. 61953. It is preferred that there be only minimal amounts of other materials present when the fragrance is added to the silica particles to maximize absorption. It is especially preferred that only small amounts, e.g., less than about 10% of organic materials, including waxes, be present in the admixture during fragrance absorption.

Another type of carrier suitable for use in the present invention includes cyclodextrin. As used herein, the term “cyclodextrin” (CD) includes any of the known cyclodextrins such as unsubstituted cyclodextrins containing from six to twelve glucose units especially, alpha-, beta-, gamma-cyclodextrins, their derivatives, and mixtures thereof, that are capable of forming inclusion complexes with fragrance ingredients. Alpha-, beta-, and gamma-cyclodextrins can be obtained from, among others, American Maize-products Company (Amaizo), Corn Processing Division, Hammond, Ind.; and Roquette Corporation, Gurnee, El. There are many derivatives of cyclodextrins that are known. Representative derivatives are those disclosed in U.S. Pat. No. 3,426,011, Parmerter et al., issued Feb. 4, 1969; U.S. Pat. Nos. 3,453,257, 3,453,258, 3,453,259 and 3,453,260, all in the names of Parmerter et al., and all issued Jul. 1, 1969; U.S. Pat. No. 3,459,731, Gramera et al., issued Aug. 5, 1969; U.S. Pat. No. 3,553,191, Parmerter et al., issued Jan. 5, 1971; U.S. Pat. No. 3,565,887, Parmerter et al., issued Feb. 23, 1971; U.S. Pat. No. 4,535,152, Szejtli et al., issued Aug. 13, 1985; U.S. Pat. No. 4,616,008, Hirai et al., issued Oct. 7, 1986; U.S. Pat. No. 4,638,058, Brandt et al., issued Jan. 20, 1987; U.S. Pat. No. 4,746,734, Tsuchiyama et al., issued May 24, 1988; and U.S. Pat. No. 4,678,598, Ogino et al., issued Jul. 7, 1987, U.S. Pat. No. 4,356,115, Shibanai et al., issued Oct. 26, 1982, all of said patents being incorporated herein by reference. Examples of cyclodextrin derivatives suitable for use herein are methyl-beta-CD, hydroxyethyl-beta-CD, and hydroxypropyl-.beta.-CD of different degrees of substitution (D.S.), available from Amaizo and from Aldrich Chemical Company, Milwaukee, Wis. Water-soluble, e.g., perspiration dissolving, derivatives containing sugar-type, or dextrine molecules, and derivatives, are also highly desirable.

What is claimed:

1. A telephone or sound emitting device having at least a microphone or an earphone, and attached to an outer surface of the device is a removable fragrance releasing attachment.

2. The device of claim 1 wherein the device comprises a telephone hand held device.

3. The device of claim 1 wherein the device comprises a cellular phone and at least a part of the attachment is adhesively secured to the outer surface.

4. The device of claim 3 wherein the microphone is located on the outer surface.

5. The device of claim 4 wherein all of the attachment is located on the outer surface.

6. The device of claim 4 wherein only a portion of the attachment is on the outer surface and at least another portion of the attachment is on a side of the hand held device.

7. The device of claim 3 wherein the fragrance releasing attachment comprises microcapsules containing fragrance.

8. The device of claim 1 wherein the fragrance is aromatherapeutic.

9. The device of claim 2 wherein the fragrance is aromatherapeutic.

10. The device of claim 4 wherein the fragrance is aromatherapeutic.

11. The device of claim 5 wherein the fragrance is aromatherapeutic.

12. The device of claim 1 wherein the hand held device comprises a cover and a base with the microphone in only one of the cover, a sliding element and the base, and closure of the cover with pressure stimulates release of fragrance.

13. The device of claim 2 wherein the hand held device comprises a cover and a base with the microphone in only one of the cover, a sliding element and the base, and closure of the cover with pressure stimulates release of fragrance.

14. The device of claim 4 wherein the hand held device comprises a cover and a base with the microphone in only one of the cover, a sliding element and the base, and closure of the cover with pressure stimulates release of fragrance.

15. The device of claim 5 wherein the hand held device comprises a cover and a base with the microphone in only one of the cover, a sliding element and the base, and closure of the cover with pressure stimulates release of fragrance.

16. The device of claim 7 wherein the hand held device comprises a cover and a base with the microphone in only one of the cover, a sliding element and the base, and closure of the cover with pressure stimulates release of fragrance.

17. The device of claim 8 wherein the hand held device comprises a cover and a base with the microphone in only one of the cover, a sliding element and the base, and closure of the cover with pressure stimulates release of fragrance.

18. A telephone handset device having at least a microphone, and attached to an outer surface of the device is a removable fragrance releasing attachment.

19. A telephone headset device comprising a telephone earpiece device having at least an integral or attached microphone and attached to an outer surface of the headset device or the attached microphone is a removable fragrance releasing attachment.

20. The device of claim 1 wherein the outer surface comprises wire or wireless communication between (a) a headset, an earphone or a set of earphones, or an earpiece and (b) a output jack, and attached to an outer surface of one or more of the wires or an output jack is a removable fragrance releasing attachment.

21. The device of claim 1 wherein there is a depression molded into the outer surface on a telephone handset, a portable phone, or a mobile phone, and the depression acts as a seat for a removable fragrance releasing attachment.

22. The device of claim 1 wherein there is a microphone on the outer surface and the fragrance releasing device is an annular element surrounding the microphone, with an opening in the annular device allowing sound to reach the microphone.
